(19) United States
(12) Patent Application Publication
(10) Pub. No.: US 2025/0383642 A1
(43) Pub. Date: Dec. 18, 2025

(54) METHODS AND APPARATUS TO IMPLEMENT DUAL-DRIVE REDUNDANT OUTPUT STRUCTURES

(71) Applicant: Fisher-Rosemount Systems, Inc., Round Rock, TX (US)

(72) Inventors: Kent Allan Burr, Round Rock, TX (US); Gary Keith Law, Georgetown, TX (US)

(21) Appl. No.: 18/747,108

(22) Filed: Jun. 18, 2024

(51) Int. Cl. G05B 19/042; H02M 3/155

(52) U.S. Cl. CPC G05B 19/042; H02M 3/155; G05B 2219/23265

(57) ABSTRACT

An example includes at a first state: enabling a first source electrical current path corresponding to first source electrical current regulator circuitry in circuit with a first terminal to be coupled to a field device; and enabling a first sink electrical current path corresponding to first sink electrical current regulator circuitry in circuit with a second terminal to be coupled to the field device; at a second state, enabling a second sink electrical current path corresponding to second sink electrical current regulator circuitry in circuit with the second terminal; and at a third state, disabling the first sink electrical current path.

### FIELD OF THE DISCLOSURE

This disclosure relates generally to control systems and, more particularly, to methods and apparatus to implement dual-drive redundant output structures.

### BACKGROUND

Process control systems, like those used in chemical, petroleum, pharmaceutical, pulp and paper, or other manufacturing processes, typically include one or more process controllers communicatively coupled to one or more field devices configured to communicate via analog, digital or combined analog/digital communication protocols. In such process control systems, each field device is typically coupled to a process controller via one or more I/O cards.

### BRIEF DESCRIPTION OF THE DRAWINGS

FIG. 1 is a block diagram illustrating an example process control system in which input-output (I/O) cards implement a dual-drive redundant output structure.

FIG. 2 is a circuit diagram of an example implementation of the I/O cards of FIG. 1.

FIG. 3 is another circuit diagram of an example implementation of the I/O cards of FIG. 1 including communication circuitry.

FIG. 4 is an example schematic diagram that may be used to implement electrical current regulator circuitry of FIGS. 2 and 3.

FIG. 5 is an example schematic diagram that may be used to implement electrical current measurement circuitry of FIGS. 2 and 3.

FIG. 6A is an example primary-active operating state table showing operating states corresponding to different combinations of switch states in the I/O cards of FIGS. 1-3.

FIG. 6B is an example secondary-active operating state table showing operating states corresponding to different combinations of switch states in the I/O cards of FIGS. 1-3.

FIG. 7 is a diagram showing an electrical current flow path for a primary-active state of the I/O cards of FIGS. 1-3.

FIG. 8 is a diagram showing an electrical current flow path for a secondary-active state of the I/O cards of FIGS. 1-3.

FIG. 9A is a flowchart representative of example machine-readable instructions and/or example operations that may be executed, instantiated, and/or performed by example programmable circuitry to configure the I/O cards of FIGS. 1-3 to operate in a primary-active operating state.

FIG. 9B is a flowchart representative of example machine-readable instructions and/or example operations that may be executed, instantiated, and/or performed by example programmable circuitry to configure the I/O cards of FIGS. 1-3 to operate in a secondary-active operating state.

FIG. 10 is a block diagram of an example implementation of the microcontrollers of FIGS. 1-3.

FIG. 11 is a block diagram of another example implementation of the microcontrollers of FIGS. 1-3.

In general, the same reference numbers will be used throughout the drawings and accompanying written description to refer to the same or like parts. The figures are not necessarily to scale.

### DETAILED DESCRIPTION

Examples disclosed herein may be used to implement dual-drive redundant output structures to regulate electrical current that drives field devices in process control systems. In examples disclosed herein, two input-output (I/O) cards (e.g., a primary I/O card and a secondary I/O card) to control and drive a field device are connected to the field device in parallel to provide dual-drive redundancy. For example, each I/O card has an output channel that is connected to the field device through a terminal interface. Each output channel has electrical current regulation circuitry that provides current regulation control at both source and sink terminals of the field device. Examples disclosed herein monitor the electrical current flow at both the source and sink terminals. Examples disclosed herein enable and disable source electrical current paths and sink electrical current paths of the parallel-connected I/O cards in different sequences to handover control and drive of the field device between the two I/O cards under different operating conditions (e.g., a single-card drive configuration, a dual-card drive configuration). In examples disclosed herein, as long as one of the I/O cards is sourcing the regulated current to the field device at any given point in time, examples disclosed herein provide a specified target current to the field device.

Examples disclosed herein provide multiple operating states of the I/O cards in which different source and sink electrical current paths to the field device are enabled/disabled to create make-before-break current paths through the field device without doubling the electrical current to the field device. The I/O cards can be cycled quickly through transition operating states so that switchover from one I/O card to another can be substantially instantaneous from the perspective of a field device. As such, examples disclosed herein may be used to implement controlled switchovers between sources of control and drive current to the field device. This substantially reduces or eliminates a window for drop-out that could otherwise result from an uncontrolled switchover between the sources of control and drive current to the field device. In doing so, examples disclosed herein substantially reduce or eliminate the likelihood of negatively affecting normal operation of the field device (e.g., prevent field device resets due to low electrical current drive).

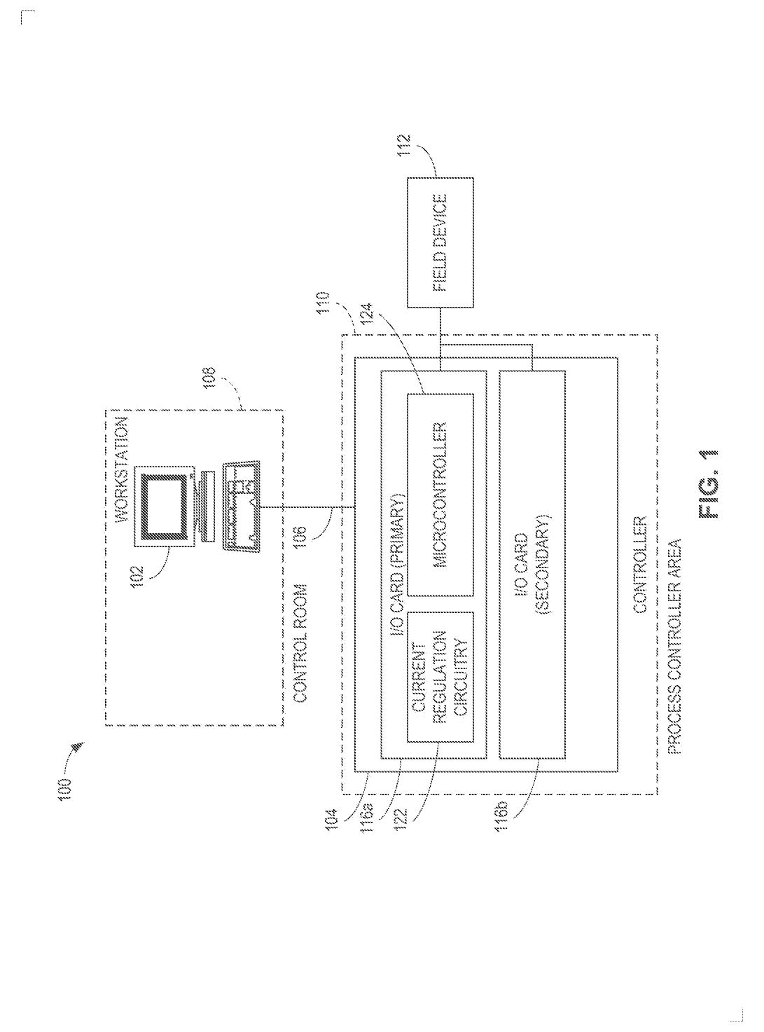

Now turning to FIG. 1, an example process control system 100 (e.g., a distributed control system or any other control system) includes a workstation 102 communicatively coupled to a controller 104 via a bus or local area network (LAN) 106. The LAN 106 is also referred to as an application control network (ACN). The LAN 106 may be implemented using any desired communication medium and protocol. For example, the LAN 106 may be based on a hardwired or wireless Ethernet communication protocol. However, any other suitable wired or wireless communication medium and protocol could be used. The workstation 102 may be configured to perform operations associated with one or more information technology applications, user-interactive applications, and/or communication applications. For example, the workstation 102 may be configured to perform operations associated with process control-related applications and communication applications that enable the workstation 102 and the controller 104 to communicate with other devices or systems using any desired communication media (e.g., wireless, hardwired, etc.) and protocols (e.g., HTTP, SOAP, etc.). The controller 104 may be configured to perform one or more process control routines or functions that have been generated by a system engineer or other system operator using, for example, the workstation 102 or any other workstation. The process control routines or functions may be downloaded to and instantiated in the controller 104. In the illustrated example, the workstation 102 is located in a control room 108 and the controller 104 is located in a process controller area 110 separate from the control room 108.

In the illustrated example, the process control system 100 includes a field device 112. In the illustrated example, communications between the controller 104 and the field device 112 are bidirectional.

The field device 112 may be HART compliant valves, actuators, sensors, etc., in which case the field device 112 communicates via HART communication protocols. Of course, other types of field devices and communication protocols could be used instead. In some examples, the field device 112 can communicate information using analog communications or discrete communications (e.g., digital communications). In addition, the communication protocols can be used to communicate information associated with different data types.

To control I/O communications between the controller 104 (and/or the workstation 102) and the field device 112, the controller 104 is provided with I/O cards 116a,b. In the illustrated example, the I/O cards 116a,b are configured to control I/O communications between the controller 104 (and/or the workstation 102) and the field device 112. In some examples, the I/O cards 116a,b can be implemented using distributed CHARMs developed and sold by Emerson Electric Company of the United States of America. Alternatively, the I/O cards 116a,b could be any devices providing electrical current regulation and to maintain a redundant pair for analog output to a target device (e.g., the field device 112). In any case, each of the I/O cards 116a,b is assigned an address (e.g., by the controller 104 of FIG. 1) so that communications can be routed to the I/O cards 116a,b based on those addresses. In some examples, the primary I/O card 116a is assigned an odd address and the secondary I/O card 116b could be assigned an even address. Alternatively, any other addressing or identification scheme may be used.

In the illustrated example of FIG. 1, the I/O cards 116a,b reside in the controller 104. To communicate information from the field device 112 to the workstation 102, the I/O cards 116a,b communicate the information to the controller 104, and the controller 104 communicates the information to the workstation 102. Similarly, to communicate information from the workstation 102 to the field device 112, the workstation 102 communicates the information to the controller 104, the controller 104 then communicates the information to the I/O cards 116a,b, and the I/O cards 116a,b communicate the information to the field device 112. In an alternative example implementation, the I/O cards 116a,b can be communicatively coupled to the LAN 106 internal to the controller 104 so that the I/O cards 116a,b can communicate directly with the workstation 102 and/or the controller 104.

To provide fault tolerant operations in the event that the primary I/O card 116a fails or is otherwise transitioned offline, the secondary I/O card 116b is configured as a redundant I/O card relative to the I/O card 116a. That is, when the primary I/O card 116a fails or goes offline, the secondary I/O card 116b assumes control and performs the same operations as the primary I/O card 116a would otherwise perform.

The primary I/O card 116a includes example current regulation circuitry 122 and an example microcontroller 124 (e.g., microcontroller circuitry). The microcontroller 124 is in circuit with the current regulation circuitry 122 to control electrical current regulation performed by the current regulation circuitry 122. Although not shown, the secondary I/O card 116b also includes current regulation circuitry substantially similar or identical to the current regulation circuitry 122 and a microcontroller substantially similar or identical to the microcontroller 124.

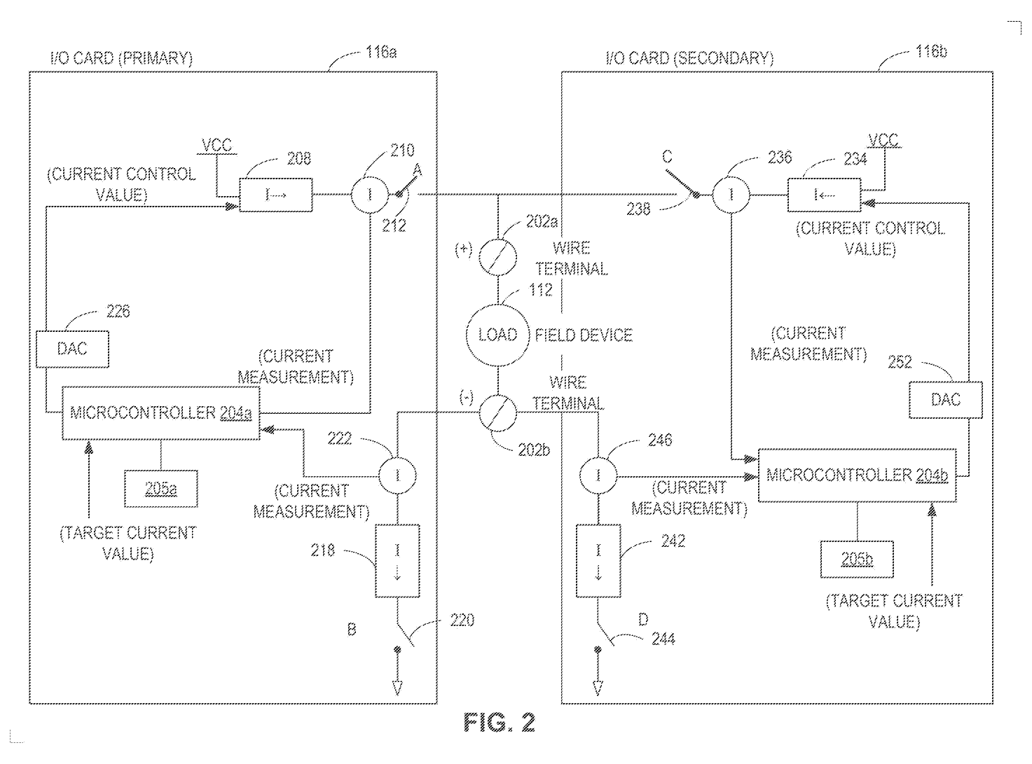

FIG. 2 is a block diagram of an example implementation of the I/O cards 116a,b of FIG. 1. The I/O cards 116a,b are coupled to field device interface terminals that include an example source field device interface terminal 202a and an example sink field device interface terminal 202b. The field device interface terminals 202a,b are provided to couple the I/O cards 116a,b to the field device 112 via wired connections. The field device interface terminals 202a,b correspond to one communication channel. In other examples, each I/O card 116a,b may include multiple communication channels to drive and control multiple field devices in accordance with teachings of this disclosure. Each of the I/O cards 116a,b includes a corresponding example microcontroller 204a,b (e.g., a primary microcontroller 204a and a secondary microcontroller 204b). The microcontrollers 204a,b are substantially similar or identical to the microcontroller 124 of FIG. 1.

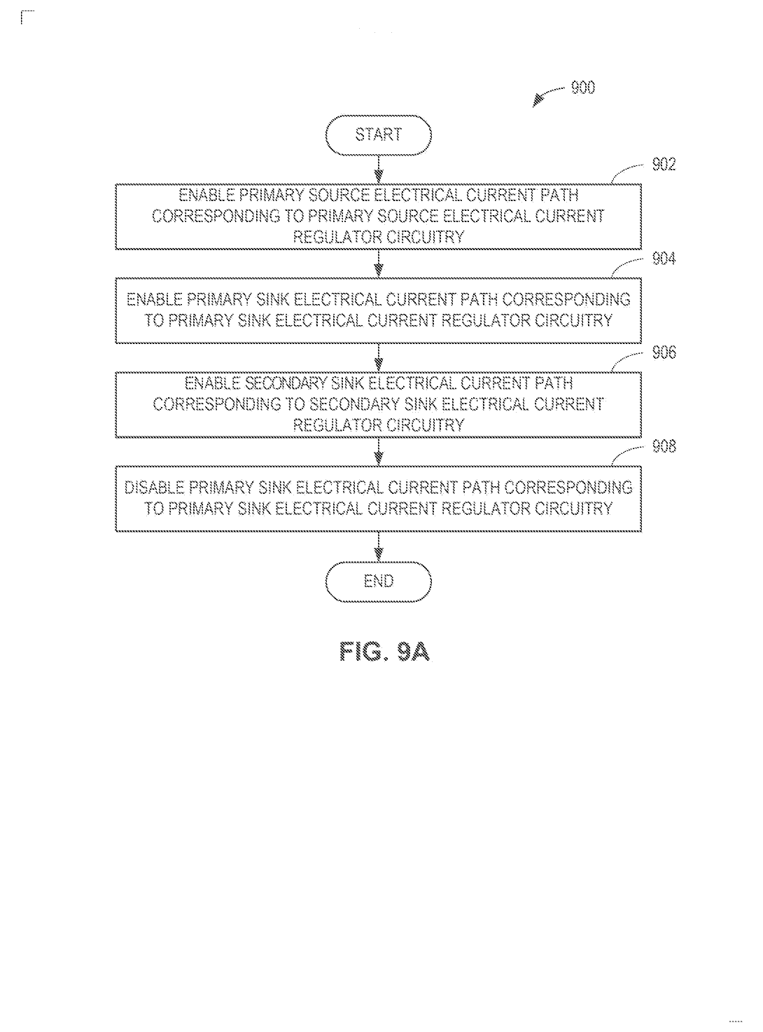

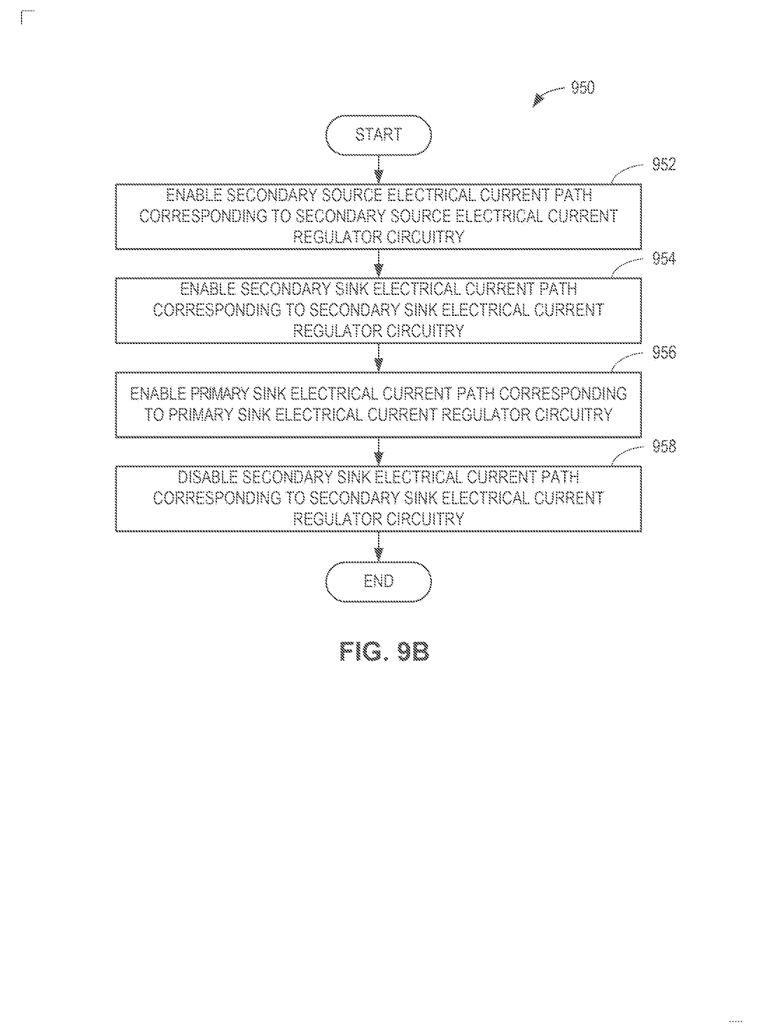

Each of the I/O cards 116a,b also includes example memory or storage 205a,b coupled to respective ones of the microcontrollers 204a,b. The memory or storage 205a,b are provided to store data and/or machine-readable instructions to perform operations related to controlling the I/O cards 116a,b and/or the field device 112. For example, the memory or storage 205a,b may store the machine-readable instructions of FIGS. 9A and 9B. The memory or storage 205a,b may be implemented using any type of memory and/or storage device. For example, the memory or storage 205a,b may be implemented using a volatile memory device such as static random access memory (SRAM), Synchronous Dynamic Random Access Memory (SDRAM), Dynamic Random Access Memory (DRAM), RAMBUS® Dynamic Random Access Memory (RDRAM®), and/or any other type of RAM device. Additionally or alternatively, the memory or storage 205a,b may be implemented using a nonvolatile memory or storage device such as magnetic storage devices (e.g., floppy disks, hard disk drives, etc.), optical storage devices (e.g., Blu-ray disks, compact discs (CDs), digital versatile discs (DVDs), etc.), electrically erasable programmable read-only memory (EEPROM), and/or solid-state drives (SSDs) or devices such as flash memory devices.

In example FIG. 2, the primary I/O card 116a includes example primary source current regulator circuitry 208 (e.g., source electrical current regulator circuitry), example primary source current measurement circuitry 210 (e.g., source electrical current measurement circuitry), example primary source switch circuitry 212, example primary sink current regulator circuitry 218 (e.g., sink electrical current regulator circuitry), example primary sink current measurement circuitry 222 (e.g., sink electrical current measurement circuitry), and example primary sink switch circuitry 220. The primary source current regulator circuitry 208 and the primary sink current regulator circuitry 218 implement the current regulation circuitry 122 of FIG. 1.

In example FIG. 2, a supply voltage (VCC) is provided to the primary source current regulator circuitry 208. The primary source current regulator circuitry 208 generates an electrical current (e.g., a drive current) to drive the field device 112. In some examples, the electrical current output could be in the range of 4-20 milliamps (mA). However, any other amount of electrical current could be provided. The primary source switch circuitry 212 has a first terminal coupled to an output of the primary source current regulator circuitry 208. The primary source switch circuitry 212 may be implemented using a relay, a transistor, an analog switch, a manual switch, an opto-electronic isolated switch, or any other suitable switch structure. The primary source switch circuitry 212 has a second terminal coupled to a source device interface terminal 202a. The source device interface terminal 202a is coupled to the field device 112.

The primary sink current regulator circuitry 218 has an input coupled to the sink field device interface terminal 202b. The sink field device interface terminal 202b is coupled to the field device 112. The primary sink current regulator circuitry 218 is provided to implement granular control over the amount of electrical current (e.g., drive current) that flows through the field device 112. The primary sink switch circuitry 220 has a first terminal coupled to an output of the primary sink current regulator circuitry 218. The primary sink switch circuitry 220 has a second terminal coupled to ground. The primary sink switch circuitry 220 may be implemented using a relay, a transistor, an analog switch, a manual switch, an opto-electronic isolated switch, or any other suitable switch structure.

In example FIG. 2, the primary source current measurement circuitry 210 is coupled to the primary source current regulator circuitry 208 to measure an electrical current output by the primary source current regulator circuitry 208. While example FIG. 2 shows the primary source current measurement circuitry 210 coupled to the output of the primary source current regulator circuitry 208, in other examples, the primary source current measurement circuitry 210 may be coupled to the input of the primary source current regulator circuitry 208. In addition, the primary sink current measurement circuitry 222 is coupled to the primary sink electrical current regulator circuitry 218 to measure an electrical current that flows through the primary sink current regulator circuitry 218. While example FIG. 2 shows the primary sink current measurement circuitry 222 coupled to the input of the primary sink current regulator circuitry 218, in other examples, the primary sink current measurement circuitry 222 may be coupled to the output of the primary sink current regulator circuitry 218.

In example FIG. 2, the primary microcontroller 204a has a first input coupled to an output of the primary source current measurement circuitry 210, a second input coupled to an output of the primary sink current measurement circuitry 222, and an output coupled to an input of the primary source current regulator circuitry 208. In the illustrated example, the output of the primary microcontroller 204a is coupled to the input of the primary source current regulator circuitry 208 via an example primary digital-to-analog converter (DAC) 226.

The primary microcontroller 204a receives a “target current value” (e.g., a target electrical current value) from, for example, the controller 104 of FIG. 1. In the illustrated example, the target current value specifies how much electrical current the primary source current regulator circuitry 208 is to generate and output to the field device 112. The primary microcontroller 204a generates a “current control value” (e.g., an electrical current control value) and provides it to the primary source current regulator circuitry 208 to control the amount of electrical current generated by the primary source current regulator circuitry 208. The primary microcontroller 204a receives and monitors electrical current measurements from the primary source current measurement circuitry 210 and the primary sink current measurement circuitry 222 as feedback signals to determine whether the amount of electrical current supplied to the field device 112 satisfies the target current value received at the primary microcontroller 204a. If the target current value is not satisfied, the primary microcontroller 204a uses the electrical current measurements and the target current value in combination with a control routine to adjust the current control value. The primary microcontroller 204a outputs the current control value to the primary source current regulator circuitry 208 to adjust the amount of electrical current supplied by the primary source current regulator circuitry 208.

The primary microcontroller 204a outputs the current control value as a digital value which the primary DAC 226 converts to an analog value. In some examples, the primary microcontroller 204a executes a program (e.g., machine-executable instructions) structured to control operations of the field device 112 by adjusting the electrical current regulation of the primary source current regulator circuitry 208. The program can include control routines that analyze the amounts of the electrical currents measured by the primary source current measurement circuitry 210 and the primary sink current measurement circuitry 222. Based on the electrical current measures, the primary microcontroller 204a can generate or adjust the current control value so that the primary source current regulator circuitry 208 can generate an amount of electrical current that satisfies the target current value to control operations or states of the field device 112. Additionally or alternatively, control software is executed at the workstation 102 (FIG. 1), and the primary microcontroller 204a receives control commands or control objectives from the workstation 102 to control the field device 112.

In example FIG. 2, the secondary I/O card 116b includes example secondary source current regulator circuitry 234 (e.g., source electrical current regulator circuitry), example secondary source current measurement circuitry 236 (e.g., source electrical current measurement circuitry), example secondary source switch circuitry 238, example secondary sink current regulator circuitry 242 (e.g., sink electrical current regulator circuitry), example secondary sink current measurement circuitry 246 (e.g., sink electrical current measurement circuitry), and example secondary sink switch circuitry 244. In example FIG. 2, a supply voltage (VCC) is provided to the secondary source electrical current regulator circuitry 234. The secondary source electrical current regulator circuitry 234 generates an electrical current (e.g., a drive current) to drive the field device 112. The secondary source switch circuitry 238 has a first terminal coupled to an output of the secondary source current regulator circuitry 234. The secondary source switch circuitry 238 may be implemented using a relay, a transistor, an analog switch, a manual switch, an opto-electronic isolated switch, or any other suitable switch structure. The secondary source switch circuitry 238 has a second terminal coupled to the source device interface terminal 202a.

The secondary sink current regulator circuitry 242 has an input coupled to the sink field device interface terminal 202b. The secondary sink current regulator circuitry 242 is provided to implement granular control over the amount of electrical current (e.g., drive current) that flows through the field device 112. The secondary sink switch circuitry 244 has a first terminal coupled to an output of the secondary sink current regulator circuitry 242, and has a second terminal coupled to ground. The secondary sink switch circuitry 244 may be implemented using a relay, a transistor, an analog switch, a manual switch, an opto-electronic isolated switch, or any other suitable switch structure.

By coupling the primary source switch circuitry 212 of the primary I/O card 116a and the secondary source switch circuitry 238 of the secondary I/O card 116b to the source device interface terminal 202a and coupling the primary sink switch circuitry 220 of the secondary I/O card 116b and the secondary source switch circuitry 238 of the secondary I/O card 116b to the sink field device interface terminal 202b, the secondary I/O card 116b can operate in a failover mode to drive an electrical current to the field device 112 in response to a failure or offline state of the primary I/O card 116a.

In example FIG. 2, the secondary source current measurement circuitry 236 is coupled to the secondary source current regulator circuitry 234 to measure an electrical current output by the secondary source current regulator circuitry 234. While example FIG. 2 shows the secondary source current measurement circuitry 236 coupled to the output of the secondary source current regulator circuitry 234, in other examples, the secondary source current measurement circuitry 236 may be coupled to the input of the secondary source current regulator circuitry 234. In addition, the secondary sink current measurement circuitry 246 is coupled to the secondary sink current regulator circuitry 242 to measure an electrical current that flows through the secondary sink current regulator circuitry 242. While example FIG. 2 shows the secondary sink current measurement circuitry 246 coupled to the input of the secondary sink current regulator circuitry 242, in other examples, the secondary sink current measurement circuitry 246 may be coupled to the output of the secondary sink current regulator circuitry 242.

In example FIG. 2, the secondary microcontroller 204b has a first input coupled to an output of the secondary source current measurement circuitry 236, a second input coupled to an output of the secondary sink current measurement circuitry 246, and an output coupled to an input of the secondary source current regulator circuitry 234. In the illustrated example, the output of the secondary microcontroller 204b is coupled to the input of the secondary source current regulator circuitry 234 via an example secondary DAC 252. The secondary microcontroller 204b of the secondary I/O card 116b executes a program substantially similar or identical to the program executed by the primary microcontroller 204a of the primary I/O card 116a. In this manner, if the primary I/O card 116a fails or goes offline, the secondary microcontroller 204b operates in failover mode to analyze the amounts of the electrical currents measured by the secondary source current measurement circuitry 236 and the secondary sink current measurement circuitry 246. Based on the electrical current measures and a target current value provided by, for example, the controller 104 of FIG. 1, the secondary microcontroller 204b generates or adjusts a current control value provided to the secondary source current regulator circuitry 234 so that the secondary source current regulator circuitry 234 can generate an amount of electrical current corresponding to the target current value to control operations or states of the field device 112.

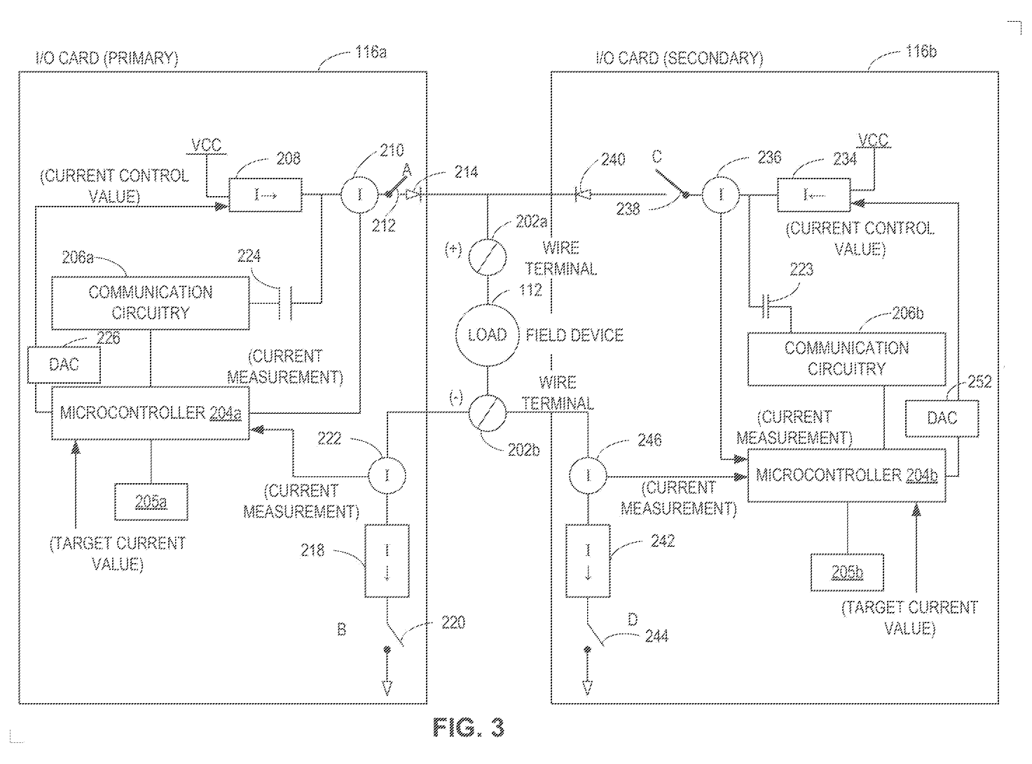

FIG. 3 is another circuit diagram of an example implementation of the I/O cards 116a,b of FIG. 1 including example communication circuitry 206a,b (e.g., primary communication circuitry 206a and secondary communication circuitry 206b). For purposes of brevity, components of the I/O cards 116a,b repeated in FIG. 3 are not described again below. Instead, the interested reader is referred to their descriptions above. The communication circuitry 206a,b perform modem operations to send control communications (e.g., commands, data, etc.) to the field device 112. In the primary I/O card 116a of example FIG. 3, an output of the primary microcontroller 204a is coupled to an input of the primary communication circuitry 206a. For example, the primary microcontroller 204a can provide control signals or commands to the primary communication circuitry 206a, and the primary communication circuitry 206a can perform modem operations on the control signals or commands to send the control signals or commands as analog communication signals or digital communication signals to the field device 112.

The primary communication circuitry 206a has an output that is capacitively coupled to the output of the primary source current regulator circuitry 208 via an example coupling capacitor 224 (e.g., a filter capacitor). Through the capacitive coupling, the analog or digital communication signals provided by the primary communication circuitry 206a are injected as peak-to-peak signals on top of the steady-state regulated electrical current provided by the primary source current regulator circuitry 208 in a primary source electrical current path. In this manner, both the communication signals from the primary communication circuitry 206a and the steady-state regulated electrical current are simultaneously provided to the field device 112.

The primary microcontroller 204a controls the amount of regulated electrical current to cause the field device 112 to operate in different manners in accordance with the amount of electrical current. For example, if the field device 112 is a valve, the amount of regulated electrical current generated by the primary source current regulator circuitry 208 in the analog domain may control an opening size of the valve to allow more or less fluid to flow through the valve (e.g., drive different regulated electrical current values for different partially open valve positions). Additionally, digital communication signals provided by the primary communication circuitry 206a may be used for diagnostics tests, status information, and/or information specifying the type of field device and date of manufacture. In some examples, the amount of regulated electrical current controlled by the primary microcontroller 204a supplies a current bias to the field device 112. The field device 112 can use such current bias to perform certain operations (e.g., the electrical current may calibrate a sensor to control the accuracy of sensor readings).

In example FIG. 3, the primary I/O card 116a includes an example current back-feed prevention component 214 having an input and an output. For example, the current back-feed prevention component 214 may be implemented using a diode or any other electronic component to prevent back-feed of electrical current into the primary source current regulator circuitry 208. In example FIG. 3, the second terminal of the primary source switch circuitry 212 is coupled to the source device interface terminal 202a via the current back-feed prevention component 214. For example, the input of the current back-feed prevention component 214 is coupled to the second terminal of the primary source switch circuitry 212, and the output of the current back-feed prevention component 214 is coupled to the source device interface terminal 202a. In some examples, the current back-feed prevention component 214 may instead be implemented in the primary source current regulator circuitry 208.

In the secondary I/O card 116b, the secondary microcontroller 204b is coupled to the secondary communication circuitry 206b. The secondary communication circuitry 206b has an output that is capacitively coupled to an output of the secondary source current regulator circuitry 234 via an example capacitor 223 (e.g., a filter capacitor). The secondary microcontroller 204b and the secondary communication circuitry 206b operate substantially similarly or identically to the primary microcontroller 204a and the primary communication circuitry 206a of the primary I/O card 116a when the secondary I/O card 116b undertakes control of the field device 112 after failure of the primary I/O card 116a or after the primary I/O card 116a is transitioned offline. For example, through capacitive coupling of the capacitor 223, analog or digital communication signals provided by the secondary communication circuitry 206b are injected as peak-to-peak signals on top of the steady-state regulated electrical current provided by the secondary source current regulator circuitry 234 in a secondary source electrical current path. In this manner, both the communication signals from the secondary communication circuitry 206b and the steady-state regulated electrical current are simultaneously provided to the field device 112. The secondary microcontroller 204b controls the amount of regulated electrical current to cause the field device 112 to operate in different manners in accordance with the amount of electrical current. Additionally or alternatively, the secondary microcontroller 204b controls the amount of regulated electrical current to supply a current bias to the field device 112 to perform certain operations.

The secondary I/O card 116b also includes an example current back-feed prevention component 240 substantially similar or identical to the current back-feed prevention component 214. The current back-feed prevention component 240 prevents back-feed of electrical current into the secondary source current regulator circuitry 234. In example FIG. 3, the second terminal of the secondary source switch circuitry 238 is coupled to the source device interface terminal 202a via the current back-feed prevention component 240. For example, the input of the current back-feed prevention component 240 is coupled to the second terminal of the secondary source switch circuitry 238, and the output of the current back-feed prevention component 240 is coupled to the source device interface terminal 202a. In some examples, the current back-feed prevention component 240 may instead be implemented in the secondary source current regulator circuitry 234.

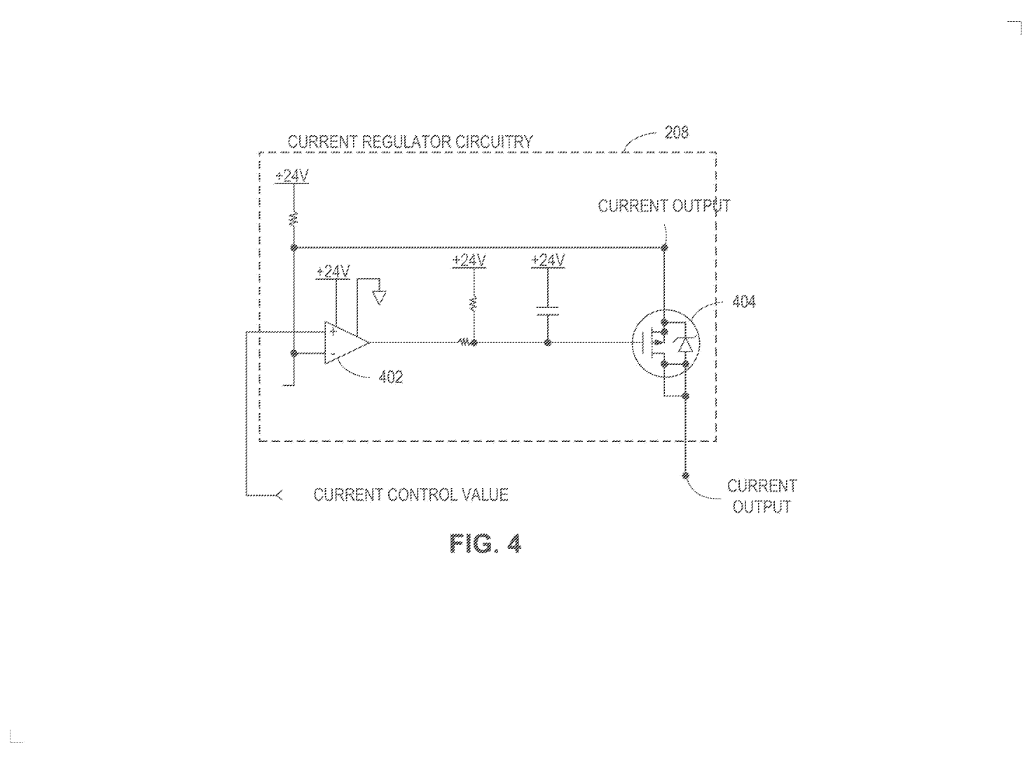

FIG. 4 is an example schematic diagram that may be used to implement the primary source current regulator circuitry 208 of FIGS. 2 and 3. In example FIG. 4, the primary source current regulator circuitry 208 includes an example operational amplifier (op-amp) 402 and an example field-effect transistor (FET) 404. The op-amp 402 is provided to control an amount of gain to be applied to electrical current. The FET 404 is a type of transistor that uses an electric field to control the flow of electrical current in a circuit.

In example FIG. 4, the supply voltage (e.g., VCC) is +24 volts and a target electrical current value is received at an input of the op-amp 402 from the primary microcontroller 204a (e.g., via the DAC 226) of FIGS. 2 and 3. An output of the op-amp 402 is coupled to a gate terminal of the FET 404 to control how much electrical current flows between drain and source terminals of the FET 404. The drain and source terminals of the FET 404 provide current output nodes at which regulated electrical current is provided by the primary source current regulator circuitry 208.

The primary sink current regulator circuitry 218, the secondary source current regulator circuitry 234, and the secondary sink current regulator circuitry 242 may also be implemented using circuitry substantially similar or identical to the example circuitry shown in FIG. 4. However, the schematic diagram of FIG. 4 is merely one example circuit that may be used to implement the current regulator circuitry 208, 218, 234, and 242. Any other suitable type of circuitry may be used to implement the current regulator circuitry 208, 218, 234, and 242.

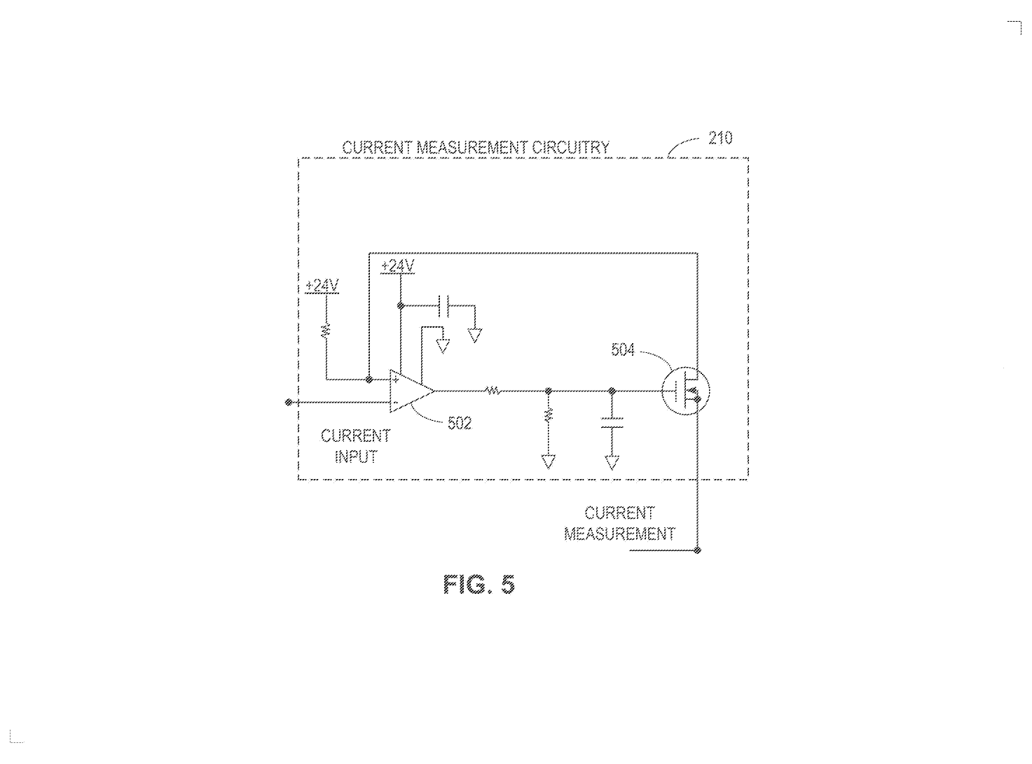

FIG. 5 is an example schematic diagram that may be used to implement the primary source current measurement circuitry 210 of FIGS. 2 and 3. In example FIG. 5, the primary source current measurement circuitry 210 includes an example op-amp 502 and an example FET 504. In example FIG. 5, the supply voltage (e.g., VCC) is +24 volts and an input of the op-amp 502 receives an electrical current input. For example, the electrical current input is the regulated current output generated by the primary source current regulator circuitry 208 of FIGS. 2-4. In this manner, the primary source current measurement circuitry 210 can measure the amount of the regulated current generated by the primary source current regulator circuitry 208 and provide the measured current value as a current measurement to the primary microcontroller 204a. A program executed the primary microcontroller 204a can analyze the electrical current measurement and implement a responsive control for the field device 112.

The primary sink current measurement circuitry 222, the secondary source current measurement circuitry 236, and the secondary sink current measurement circuitry 246 may also be implemented using circuitry substantially similar or identical to the example circuitry shown in FIG. 5. However, the schematic diagram of FIG. 5 is merely one example circuit that may be used to implement the current measurement circuitry 210, 222, 236, and 246. Any other suitable type of circuitry may be used to implement the current measurement circuitry 210, 222, 236, and 246.

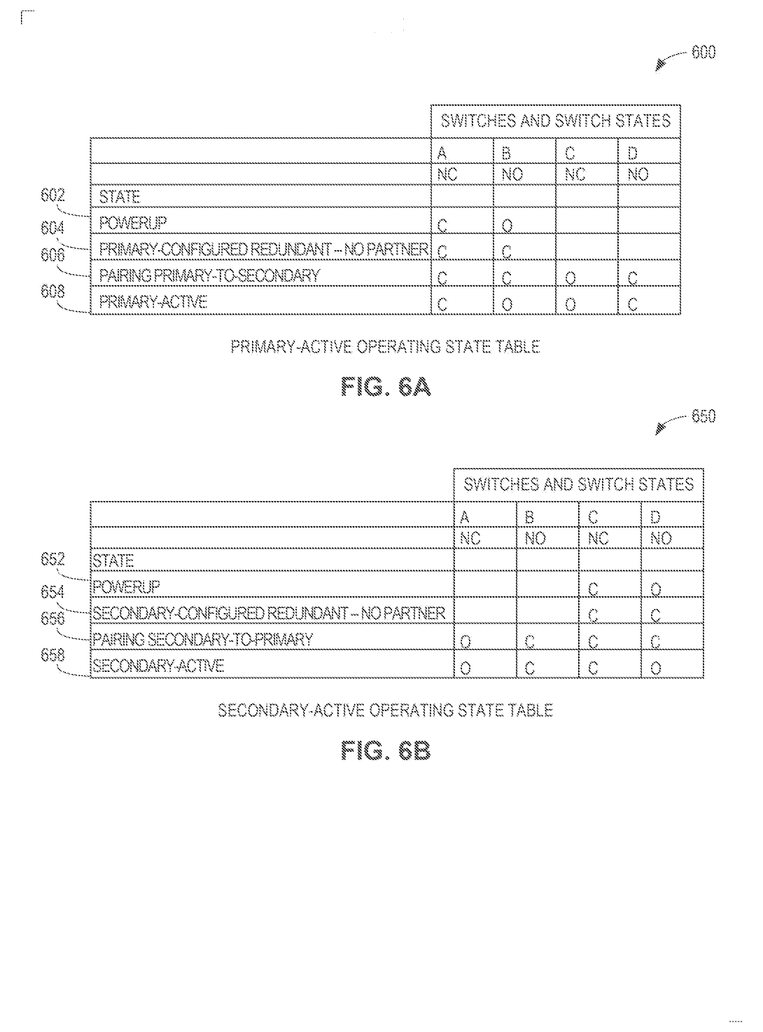

FIG. 6A is an example primary-active operating state table 600 showing operating states corresponding to different combinations of switch states in the I/O cards 116a,b of FIGS. 1-3 to transition the I/O cards 116a,b to a primary-active operating state. FIG. 6B is an example secondary-active operating state table 650 showing operating states corresponding to different combinations of switch states in the I/O cards of FIGS. 1-3 to transition the I/O cards 116a,b to a secondary-active operating state. The switch states identified in the operating state tables 600 and 650 correspond to open and closed states or positions of the primary source switch circuitry 212 (denoted by switch label ‘A’), the primary sink switch circuitry 220 (denoted by switch label ‘B’), the secondary source switch circuitry 238 (denoted by switch label ‘C’), and the secondary sink switch circuitry 244 (denoted by switch label ‘D’). The operating states correspond to how the I/O cards 116a,b are supplying electrical current and control signals to the field device 112 via the terminals 202a,b of FIGS. 2 and 3.

As used herein, an open state of a switch is defined as a switch state that prevents electrical current from flowing through the switch. The open state can also be referred to as an open circuit, a disabled state, an off state, a current-blocking state, or any other suitable language to represent that electrical current is not allowed to flow through a path in which the open switch is located. As used herein, a closed state of a switch is defined as a switch state that allows electrical current to flow through the switch. The closed state can also be referred to as a closed circuit, an enabled state, an on state, or any other suitable language to represent that electrical current is allowed to flow through a path in which the closed switch is located.

Some of the operating states in FIGS. 6A and 6B are transition states in which control and drive of the field device 112 are transitioned between the primary I/O card 116a and the secondary I/O card 116b. For example, in response to the primary I/O card 116b being brought online while the primary I/O card 116a is driving and controlling the field device 112, the microcontrollers 204a,b can control the on/off states of the switches 212, 220, 238, 244 to disable/enable different source and sink electrical current paths in the I/O cards 116a,b. In this manner, the I/O cards 116a,b are configured across different transition operating states to incrementally handover drive and control between the primary I/O card 116a and the secondary I/O card 116b in a way that substantially reduces or eliminates the likelihood of drive and control disruption to the field device 112.

In addition, during the different operating states, the microcontrollers 204a,b can perform diagnostic tests to determine whether any error has occurred at the field device 112 based on one or more electrical current measurements corresponding to at least one of the source device interface terminal 202a or the sink field device interface terminal 202b. For example, the primary microcontroller 204a can analyze current measurements from the primary source current measurement circuitry 210 for electrical currents flowing along a primary source electrical current path that includes the primary source current regulator circuitry 208 and the source field device interface terminal 202a. The primary microcontroller 204a also analyzes current measurements from the primary sink current measurement circuitry 222 for electrical currents flowing along a primary sink electrical current path that includes the primary sink current regulator circuitry 218 and the sink field device interface terminal 202b. Similarly, the secondary microcontroller 204b analyzes current measurements from the secondary source current measurement circuitry 236 for electrical currents flowing along a secondary source electrical current path that includes the secondary source current regulator circuitry 234 and the source field device interface terminal 202a. The secondary microcontroller 204b also analyzes current measurements from the secondary sink current measurement circuitry 246 for electrical currents flowing along a secondary sink electrical current path that includes the secondary sink current regulator circuitry 242 and the sink field device interface terminal 202b.

Turning to FIG. 6A, if the primary I/O card 116a is plugged in or powered on before the secondary I/O card 116b, the switches of the primary I/O card 116a are configured according to the operating states of the primary-active operating state table 600 to place the primary I/O card 116a into a primary-active state 608. As shown in the primary-active operating state table 600 of FIG. 6A, the primary source switch circuitry 212 (‘A’) is closed, the primary sink switch circuitry 220 (‘B’) is open, and the secondary source switch circuitry 238 (‘C’) and the secondary sink switch circuitry 244 (‘D’) are undefined during an example powerup state 602. The secondary source switch circuitry 238 (‘C’) and the secondary sink switch circuitry 244 (‘D’) are undefined because the secondary I/O card 116b is absent or not yet powered. In the powerup state 602, the primary microcontroller 204a does not yet know whether it is to drive and control the field device 112 or how much electrical current to regulate. As such, during the powerup state 602, the primary microcontroller 204a controls the regulated electrical current to a very low value (e.g., a value that does not operate the field device 112) and performs diagnostics to confirm that the current measurements provided by the primary source current measurement circuitry 210 and the primary sink current measurement circuitry 222 are zero. The measured electrical currents should be zero in the powerup state 602 because the primary sink switch circuitry 220 (‘B’) is open and the secondary sink switch circuitry 244 (‘D’) is absent. If the measured electrical currents are not zero, a diagnostics routine of the primary microcontroller 204a can generate an error notification indicative of a fault at the field device 112.

During an example primary-configured redundant – no partner state 604, the primary source switch circuitry 212 (‘A’) and the primary sink switch circuitry 220 (‘B’) are closed, and the secondary source switch circuitry 238 (‘C’) and the secondary sink switch circuitry 244 (‘D’) are undefined. The primary-configured redundant – no partner state 604 is a symmetric drive state in which the primary I/O card 116a is driving and controlling the field device 112 independent of the secondary I/O card 116b. This primary-configured redundant – no partner state 604 is a normal operating state of the primary I/O card 116a when it is operational (e.g., without a fault and online). During initialization of the primary-configured redundant – no partner state 604, the primary microcontroller 204a can perform a diagnostic check to confirm that low values of electrical currents are measured at the primary source current measurement circuitry 210 and the primary sink current measurement circuitry 222. For example, low electrical current values are expected when a target current value is not yet provided to the primary microcontroller 204a. That is, when the type of the field device 112 is not yet known, the primary source current regulator circuitry 208 can generate a low electrical current that is sufficient to flow through the field device 112 and test continuity of a current path without damaging the field device 112.

After the primary microcontroller 204a receives a target current value and provides a current control value to the primary source current regulator circuitry 208, the primary microcontroller 204a can perform further diagnostics to confirm that the electrical currents measured at the primary source current measurement circuitry 210 and the primary sink current measurement circuitry 222 are substantially the same (e.g., within 10% of one another). During the diagnostics check, if the primary microcontroller 204a determines that the electrical currents are not substantially the same, the primary microcontroller 204a determines a fault exists in the primary I/O card 116a or in the field device 112.

For example, if the electrical current measured by the primary source current measurement circuitry 210 is more than the electrical current measured by the primary sink current measurement circuitry 222, the primary microcontroller 204a determines that a ground short could exist (e.g., due to a wire shorted to ground). Such a ground short could result in some of the electrical current provided by the primary source current regulator circuitry 208 being routed to the ground path. As such, not all of the supplied electrical current is returned through the primary sink current measurement circuitry 222. Alternatively, during the diagnostics check, the electrical current measured by the primary source current measurement circuitry 210 may be less than the electrical current measured by the primary sink current measurement circuitry 222. In such instances, the primary microcontroller 204a determines that another current source, separate from the primary source current regulator circuitry 208, is energizing the field device 112, even though the primary microcontroller 204a may still be in control of the field device 112.

During an example pairing primary-to-secondary state 606, the primary source switch circuitry 212 (‘A’), the primary sink switch circuitry 220 (‘B’), and the secondary sink switch circuitry 244 (‘D’) are closed, and the secondary source switch circuitry 238 (‘C’) is open. The pairing primary-to-secondary state 606 is a transition state that creates a “make-before-break” circuit when transitioning between the primary-configured redundant – no partner state 604 and the primary-active state 608. For example, two sink current paths are established concurrently through the primary sink switch circuitry 220 (‘B’) and the secondary sink switch circuitry 244 (‘D’) before opening or turning off the primary sink switch circuitry 220 (‘B’). In this manner, the pairing primary-to-secondary state 606 is used to maintain a current flow path through the field device 112 with substantially little or no current disturbance (e.g., current droops, current bumps, current spikes, current interruptions, etc.) to the field device 112 when changing between different source and sink paths in the I/O cards 116a,b. Accordingly, drive and control of the field device 112 is seamlessly switched between the primary-configured redundant – no partner state 604 and the primary-active state 608.

During the pairing primary-to-secondary state 606 of FIG. 6A, the microcontrollers 204a,b can perform diagnostics. The microcontrollers 204a,b can use such diagnostics to determine whether each of the electrical currents measured at the primary sink current measurement circuitry 222 and the secondary sink current measurement circuitry 246 is substantially half (e.g., within 10% of one another) of the electrical current provided by the primary source current regulator circuitry 208. This reflects whether the electrical current supplied by the primary source current regulator circuitry 208 is split, upon returning from the field device 112, substantially evenly across the primary sink electrical current path that includes the primary sink switch circuitry 220 (‘B’) and the secondary sink electrical current path that includes the secondary sink switch circuitry 244 (‘D’). If either of the electrical currents measured at the primary sink current measurement circuitry 222 or the secondary sink current measurement circuitry 246 is not substantially half (e.g., within 10% of one another) of the supplied electrical current, the corresponding microcontroller(s) 204a,b generate(s) an error notification(s). Such an error notification is indicative of a fault at one or both of the I/O cards 116a,b or at the field device 112 such that the fault is interfering with control of the electrical current supplied to the field device 112.

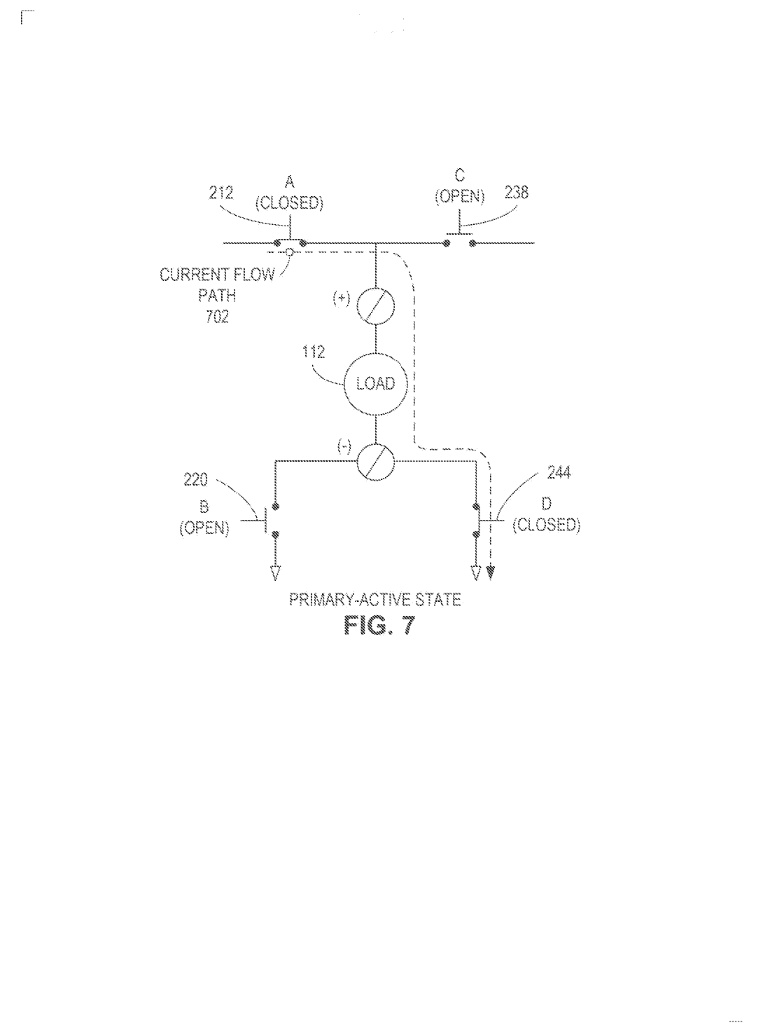

During the example primary-active state 608, the primary source switch circuitry 212 (‘A’) and the secondary sink switch circuitry 244 (‘D’) are closed, and the primary sink switch circuitry 220 (‘B’) and the secondary source switch circuitry 238 (‘C’) are open. The primary-active state 608 is the default operating state for the secondary pair of I/O cards 116a,b if the primary I/O card 116a powers up first. The primary-active state 608 is an asymmetric drive state in which a source switch (e.g., the primary source switch circuitry 212 (‘A’)) of one of the I/O cards 116a,b and a sink switch (e.g., the secondary sink switch circuitry 244 (‘D’)) of the other one of the I/O cards 116a,b share a current flow path through the field device 112. In the primary-active state 608, the current flow path through the field device 112 is formed by the primary I/O card 116a and the secondary I/O card 116b, as shown in FIG. 7.

Referring briefly to FIG. 7, an example current flow path 702 is formed by a source electrical current path corresponding to the closed primary source switch circuitry 212 (‘A’) and a sink electrical current path corresponding to the closed secondary sink switch circuitry 244 (‘D’). The primary-active state 608 represented in FIG. 7 is an asymmetric drive state in which the primary source electrical current regulator circuitry 208 of the primary I/O card 116a sources electrical current to the field device 112 and the secondary sink electrical current regulator circuitry 242 of the secondary I/O card 116b sinks the electrical current from the field device 112. In this manner, in the primary-active state 608, the primary microcontroller 204a and the primary source current regulator circuitry 208 of the primary I/O card 116a and the secondary sink current regulator circuitry 242 of the secondary I/O card 116b drive and control the field device 112.

Turning now to FIG. 6B, if the secondary I/O card 116b is plugged in or powered on before the primary I/O card 116a, the switches of the secondary I/O card 116b are configured according to the operating states of the secondary-active operating state table 650 to place the secondary I/O card 116b into a secondary-active state 658. As shown in the secondary-active operating state table 650 of FIG. 6B, the secondary source switch circuitry 238 (‘C’) is closed and the secondary sink switch circuitry 244 (‘D’) is open, and the primary source switch circuitry 212 (‘A’) and the primary sink switch circuitry 220 (‘B’) are undefined during an example powerup state 652. The primary source switch circuitry 212 (‘A’) and the primary sink switch circuitry 220 (‘B’) are undefined because the primary I/O card 116a is absent or not yet powered. In the powerup state 652, the secondary microcontroller 204b does not yet know whether it is to drive and control the field device 112 or how much electrical current to regulate. As such, during the powerup state 652, the secondary microcontroller 204b controls the regulated electrical current to a very low value (e.g., a value that does not operate the field device 112) and performs diagnostics to confirm that the current measurements provided by the secondary source current measurement circuitry 236 and the secondary sink current measurement circuitry 246 are zero. The measured electrical currents should be zero in the powerup state 652 because the secondary sink switch circuitry 244 (‘D’) is open and the primary sink switch circuitry 220 (‘B’) is absent. If the measured electrical currents are not zero, a diagnostics routine of the secondary microcontroller 204b can generate an error notification indicative of a fault at the field device 112.

During an example secondary-configured redundant – no partner state 654, the primary source switch circuitry 212 (‘A’) and the primary sink switch circuitry 220 (‘B’) are undefined, and the secondary source switch circuitry 238 (‘C’) and the secondary sink switch circuitry 244 (‘D’) are closed. The secondary-configured redundant – no partner state 654 is a symmetric drive state in which the secondary I/O card 116b is driving and controlling the field device 112 independent of the primary I/O card 116a.

During an initialization of the secondary-configured redundant – no partner state 654, the secondary microcontroller 204b can perform a diagnostic check to confirm that low values of electrical currents are measured at the secondary source current measurement circuitry 236 and the secondary sink current measurement circuitry 246. After the secondary microcontroller 204b receives a target current value and provides a current control value to the secondary source current regulator circuitry 234, the secondary microcontroller 204b can perform further diagnostics to confirm that the electrical currents measured at the secondary source current measurement circuitry 236 and the secondary sink current measurement circuitry 246 are substantially the same (e.g., within 10% of one another). During a diagnostics check, if the secondary microcontroller 204b determines that the electrical currents are not substantially the same, the secondary microcontroller 204b determines a fault exists in the secondary I/O card 116b or in the field device 112 and generates a corresponding error notification.

For example, if the electrical current measured by the secondary source current measurement circuitry 236 is more than the electrical current measured by the secondary sink current measurement circuitry 246, the secondary microcontroller 204b determines that a ground short could exist (e.g., due to a wire shorted to ground). Such a ground short could result in some of the electrical current provided by the secondary source current regulator circuitry 234 being routed to the ground path. As such, not all of the supplied electrical current is returned through the secondary sink current measurement circuitry 246. Alternatively, during the diagnostics check, the electrical current measured by the secondary source current measurement circuitry 236 may be less than is measured by the secondary sink current measurement circuitry 246. In such instances, the secondary microcontroller 204b determines that another current source, separate from the secondary source current regulator circuitry 234, is energizing the field device 112, even though the secondary microcontroller 204b may still be in control of the field device 112.

During an example pairing secondary-to-primary state 656, the primary source switch circuitry 212 (‘A’) is open, and the primary sink switch circuitry 220 (‘B’), the secondary source switch circuitry 238 (‘C’), and the secondary sink switch circuitry 244 (‘D’) are closed. The pairing secondary-to-primary state 656 is a transition state that creates a “make-before-break” circuit when transitioning between the secondary-configured redundant – no partner state 654 and the secondary-active state 658. For example, sink current paths can be established concurrently through both of the primary sink switch circuitry 220 (‘B’) and the secondary sink switch circuitry 244 (‘D’) before opening or turning off the secondary sink switch circuitry 244 (‘D’). In this manner, the pairing secondary-to-primary state 656 is used to maintain a current flow path through the field device 112 with substantially little or no current disturbance (e.g., current droops, current bumps, current spikes, current interruptions, etc.) to the field device 112 when changing between different source and sink paths in the I/O cards 116a,b. Accordingly, drive and control of the field device 112 is seamlessly switched between the secondary-configured redundant – no partner state 654 and the secondary-active state 658.

During the pairing secondary-to-primary state 656 of FIG. 6B, the microcontrollers 204a,b can perform diagnostics. The microcontrollers 204a,b can use such diagnostics to determine whether each of the electrical currents measured at the primary sink current measurement circuitry 222 and the secondary sink current measurement circuitry 246 is substantially half (e.g., within 10% of one another) of the electrical current provided by the secondary source current regulator circuitry 234. This reflects whether the electrical current supplied by the secondary source current regulator circuitry 234 is split, upon return from the field device 112, substantially evenly across the primary sink electrical current path that includes the primary sink switch circuitry 220 (‘B’) and the secondary sink electrical current path that includes the secondary sink switch circuitry 244 (‘D’). If either of the electrical currents measured at the primary sink current measurement circuitry 222 or the secondary sink current measurement circuitry 246 is not substantially half (e.g., within 10% of one another) of the supplied electrical current, the corresponding microcontroller(s) 204a,b generate(s) an error notification(s). Such an error notification is indicative of a fault at one or both of the I/O cards 116a,b or at the field device 112 such that the fault is interfering with control of the electrical current supplied to the field device 112.

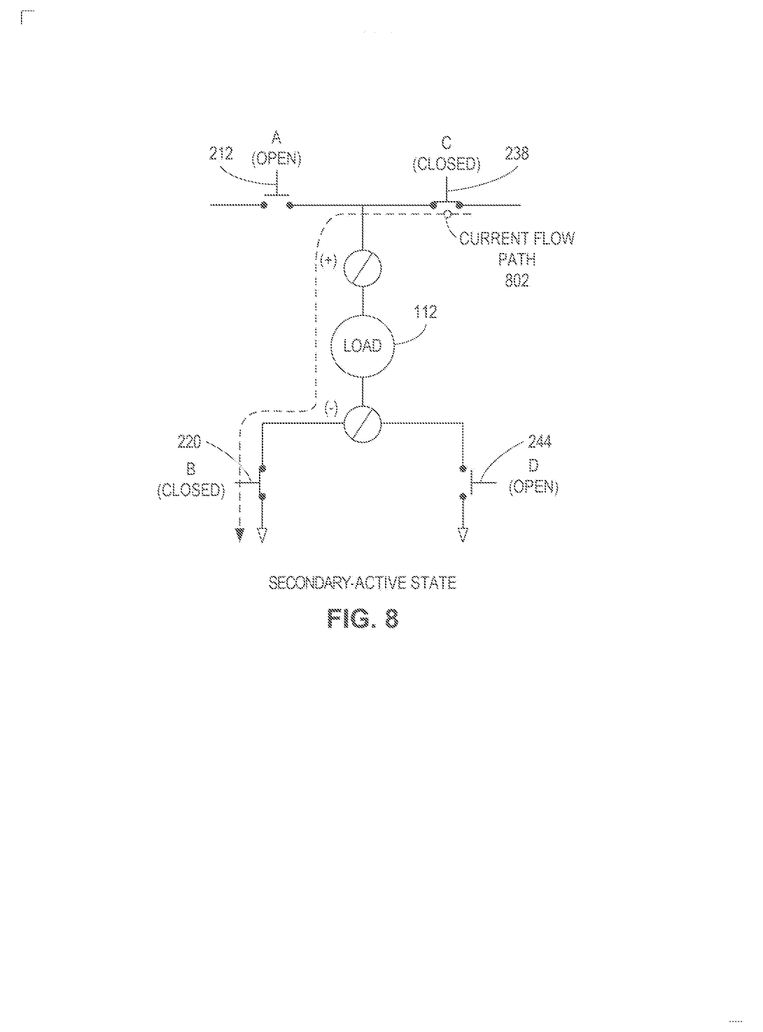

During an example secondary-active state 658, the primary source switch circuitry 212 (‘A’) and the secondary sink switch circuitry 244 (‘D’) are open, and the primary sink switch circuitry 220 (‘B’) and the secondary source switch circuitry 238 (‘C’) are closed. The secondary-active state 658 is the default operating state for the redundant pair of I/O cards 116a,b if the secondary I/O card 116b powers up first. The secondary-active state 658 is an asymmetric drive state in which a source switch (e.g., the secondary source switch circuitry 238 (‘C’)) of one of the I/O cards 116a,b and a sink switch (e.g., the primary sink switch circuitry 220 (‘B’)) of the other one of the I/O cards 116a,b share a current flow path through the field device 112. In the secondary-active state 658, the current flow path through the field device 112 is formed by the primary I/O card 116a and the secondary I/O card 116b, as shown in FIG. 8.

Referring briefly to FIG. 8, an example current flow path 802 is formed by a source electrical current path corresponding to the closed secondary source switch circuitry 238 (‘C’) and a sink electrical current path corresponding to the closed primary sink switch circuitry 220 (‘B’). The secondary-active state 658 represented in FIG. 8 is an asymmetric drive state in which the secondary source electrical current regulator circuitry 234 of the secondary I/O card 116b sources electrical current to the field device 112 and the primary sink electrical current regulator circuitry 218 of the primary I/O card 116a sinks the electrical current from the field device 112. In this manner, in the secondary-active state 658, the secondary microcontroller 204b and the secondary source current regulator circuitry 234 of the secondary I/O card 116b and the primary sink current regulator circuitry 218 of the primary I/O card 116a drive and control the field device 112.

While an example manner of implementing the I/O cards 116a,b of FIG. 1 is illustrated in FIGS. 2 and 3, one or more of the elements, processes, and/or devices illustrated in FIGS. 2 and 3 may be combined, divided, re-arranged, omitted, eliminated, and/or implemented in any other way. Further, the microcontrollers 204a,b, the communication circuitry 206a,b, the current measurement circuitry 210, 222, 236, 246, and/or, more generally, the example I/O cards 116a,b of FIGS. 2 and 3, may be implemented by hardware alone or by hardware in combination with software and/or firmware. Thus, for example, any of the microcontrollers 204a,b, the communication circuitry 206a,b, the current measurement circuitry 210, 222, 236, 246, and/or, more generally, the example I/O cards 116a,b, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example I/O cards 116a,b of FIGS. 2 and 3 may include one or more elements, processes, and/or devices in addition to, or instead of, those illustrated in FIGS. 2 and 3, and/or may include more than one of any or all of the illustrated elements, processes and devices.

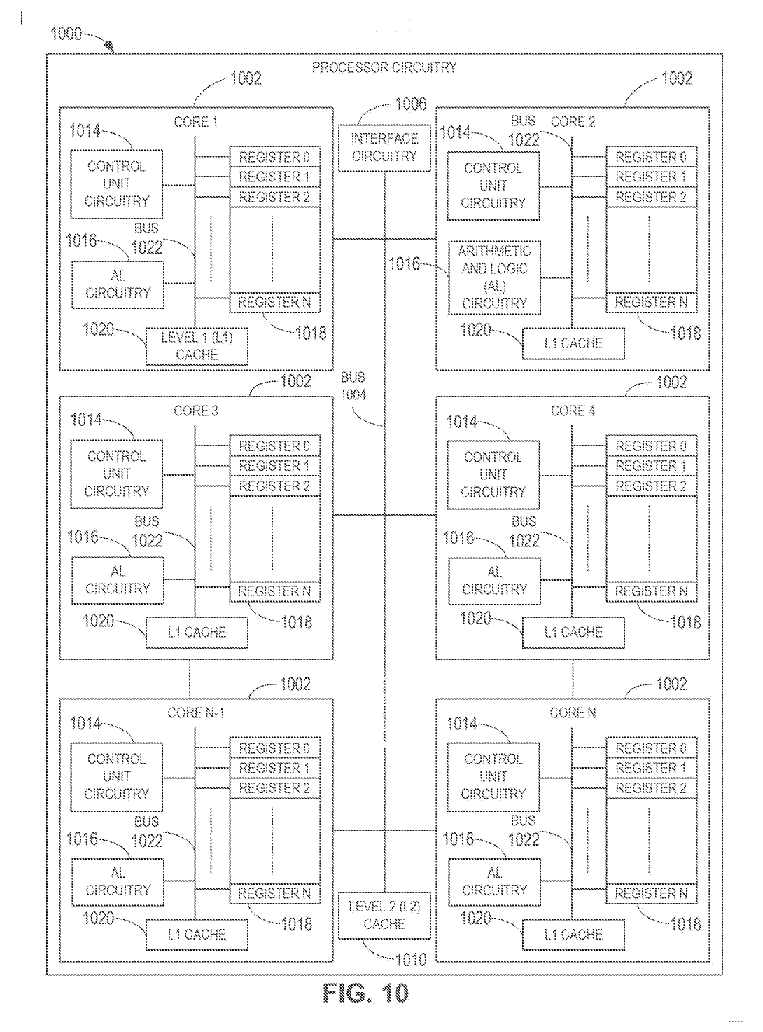

Flowcharts representative of example machine-readable instructions, which may be executed by programmable circuitry to implement and/or instantiate the I/O cards 116a,b of FIGS. 1-3 and/or representative of example operations which may be performed by programmable circuitry to implement and/or instantiate the I/O cards 116a,b of FIGS. 1-3 are shown in FIGS. 9A and 9B. The machine-readable instructions may be one or more executable programs or portion(s) of one or more executable programs for execution by programmable circuitry such as the microcontrollers 204a,b of FIGS. 2 and 3 and/or may be one or more function(s) or portion(s) of functions to be performed by the example programmable circuitry (e.g., an FPGA) discussed below in connection with FIGS. 10 and/or 11. In some examples, the machine-readable instructions cause an operation, a task, etc., to be carried out and/or performed in an automated manner in the real world. As used herein, “automated” means without human involvement.

The programs may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entireties of the programs and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums.

Further, although the example programs are described with reference to the flowcharts illustrated in FIGS. 9A and 9B, many other methods of implementing the example I/O cards 116a,b may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 9A and 9B may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 9A is a flowchart representative of example machine-readable instructions and/or example operations 900 that may be executed, instantiated, and/or performed by programmable circuitry to configure the I/O cards 116a,b of FIGS. 1-3 to operate in the primary-active state 608 of FIG. 6A. The instructions or operations 900 may be performed if the primary I/O card 116a is plugged in or powered on before the secondary I/O card 116b. The example machine-readable instructions and/or the example operations 900 of FIG. 9A begin at block 902, at which, to enter a first state (e.g., the primary-configured redundant - no partner state 604 of FIG. 6A), the primary microcontroller 204a enables a primary source electrical current path corresponding to the primary source electrical current regulator circuitry 208. As shown in FIG. 2, the primary source electrical current regulator circuitry 208 is in circuit with the source device interface terminal 202a that is to be coupled to the field device 112. For example, the primary microcontroller 204a may enable the primary source electrical current path by causing the primary source switch circuitry 212 to close (e.g., turning on the primary source switch circuitry 212, completing an electrical current path through the primary source switch circuitry 212, etc.).

Also to enter the first state (e.g., the primary-configured redundant - no partner state 604 of FIG. 6A), the primary microcontroller 204a enables a primary sink electrical current path corresponding to the primary sink electrical current regulator circuitry 218 (block 904). As shown in FIG. 2, the primary sink electrical current regulator circuitry 218 is in circuit with the sink field device interface terminal 202b that is to be coupled to the field device 112. For example, the primary microcontroller 204a may enable the primary sink electrical current path by causing the primary sink switch circuitry 220 to close (e.g., turning on the primary sink switch circuitry 220, completing an electrical current path through the primary sink switch circuitry 220, etc.). During the first state (e.g., the primary-configured redundant - no partner state 604), the field device 112 is driven and controlled by the primary I/O card 116a.

To enter a second state (e.g., the pairing primary-to-secondary state 606 of FIG. 6A), the secondary microcontroller 204b enables a secondary sink electrical current path corresponding to the secondary sink electrical current regulator circuitry 242 (block 906). As shown in FIG. 2, the secondary sink electrical current regulator circuitry 242 is in circuit with the sink field device interface terminal 202b. For example, the secondary microcontroller 204b may enable the secondary sink electrical current path by causing the secondary sink switch circuitry 244 to close (e.g., turning on the secondary sink switch circuitry 244, completing an electrical current path through the secondary sink switch circuitry 244, etc.). In some examples, the I/O cards 116a,b enter the second state (e.g., the pairing primary-to-secondary state 606) at block 906 in response to the secondary I/O card 116b being plugged into or connected to the controller 104 of FIG. 1 and/or powered up. In the second state (e.g., the pairing primary-to-secondary state 606), the secondary microcontroller 204b begins a handover process transitioning drive and control of the field device 112 from a symmetric drive state by the primary I/O card 116a to an asymmetric drive state in which the primary I/O card 116a sources current and the secondary I/O card 116b sinks the current as shown in FIG. 7. The second state (e.g., the pairing primary-to-secondary state 606) is an incremental change that substantially reduces or prevents the likelihood of introducing electrical current disruptions (e.g., current droops, current bumps, current spikes, current interruptions, etc.) to the field device 112.

To enter a third state (e.g., the primary-active state 608 of FIG. 6A and as shown in FIG. 7), the primary microcontroller 204a disables the primary sink electrical current path corresponding to the primary sink electrical current regulator circuitry 218 (block 908). For example, the primary microcontroller 204a may disable the primary sink electrical current path by causing the primary sink switch circuitry 220 to open (e.g., turning off the primary sink switch circuitry 220, blocking an electrical current path through the primary sink switch circuitry 220, etc.). In the third state (e.g., the primary-active state 608), the primary microcontroller 204a has transitioned drive and control of the field device 112 from the symmetric drive state by the primary I/O card 116a to the asymmetric drive state by both I/O cards 116a,b shown in FIG. 7. The third state (e.g., the primary-active state 608) is another incremental change to substantially reduce or prevent the likelihood of introducing electrical current disruptions to the field device 112. In some examples, the I/O cards 116a,b operate in the third state (e.g., the primary-active state 608) for an extended duration as a normal operating state. In this manner, drive and control can be quickly moved to solely the secondary I/O card 116b if the primary I/O card 116a fails or can be quickly moved solely to the primary I/O card 116a if the secondary I/O card 116b experiences a failure. The example instructions or operations 900 of FIG. 9A end.

FIG. 9B is a flowchart representative of example machine-readable instructions and/or example operations 950 that may be executed, instantiated, and/or performed by programmable circuitry to configure the I/O cards 116a,b of FIGS. 1-3 to operate in the secondary-active state 658 of FIG. 6B. The instructions or operations 950 may be performed if the secondary I/O card 116b is plugged in or powered on before the primary I/O card 116a. The example machine-readable instructions and/or the example operations 950 of FIG. 9B begin at block 952, at which, to enter a first state (e.g., the secondary-configured redundant - no partner state 654 of FIG. 6B), the secondary microcontroller 204b enables a secondary source electrical current path corresponding to the secondary source electrical current regulator circuitry 234. As shown in FIG. 2, the secondary source electrical current regulator circuitry 234 is in circuit with the source device interface terminal 202a that is to be coupled to the field device 112. For example, the secondary microcontroller 204b may enable the secondary source electrical current path by causing the secondary source switch circuitry 238 to close (e.g., turning on the secondary source switch circuitry 238, completing an electrical current path through the secondary source switch circuitry 238, etc.).

Also to enter the first state (e.g., the secondary-configured redundant - no partner state 654 of FIG. 6B), the secondary microcontroller 204b enables a secondary sink electrical current path corresponding to the secondary sink electrical current regulator circuitry 242 (block 954). As shown in FIG. 2, the secondary sink electrical current regulator circuitry 242 is in circuit with the sink field device interface terminal 202b that is to be coupled to the field device 112. For example, the secondary microcontroller 204b may enable the secondary sink electrical current path by causing the secondary sink switch circuitry 244 to close (e.g., turning on the secondary sink switch circuitry 244, completing an electrical current path through the secondary sink switch circuitry 244, etc.). During the first state (e.g., the secondary-configured redundant - no partner state 654), the field device 112 is driven and controlled by the secondary I/O card 116b.

To enter a second state (e.g., the pairing secondary-to-primary state 656 of FIG. 6B), the primary microcontroller 204a enables a primary sink electrical current path corresponding to the primary sink electrical current regulator circuitry 218 (block 956). As shown in FIG. 2, the primary sink electrical current regulator circuitry 218 is in circuit with the sink field device interface terminal 202b. For example, the primary microcontroller 204a may enable the primary sink electrical current path by causing the primary sink switch circuitry 220 to close (e.g., turning on the primary sink switch circuitry 220, completing an electrical current path through the primary sink switch circuitry 220, etc.). In some examples, the I/O cards 116a,b enter the second state (e.g., the pairing secondary-to-primary state 656) at block 956 in response to the primary I/O card 116a being plugged into or connected to the controller 104 of FIG. 1 and/or powered up. In the second state (e.g., the pairing secondary-to-primary state 656), the primary microcontroller 204a begins a handover process transitioning drive and control of the field device 112 from a symmetric drive state by the secondary I/O card 116b to an asymmetric drive state in which the secondary I/O card 116b sources current and the primary I/O card 116a sinks the current as shown in FIG. 8. The second state (e.g., the pairing secondary-to-primary state 656) is an incremental change that substantially reduces or prevents the likelihood of introducing electrical current disruptions (e.g., current droops, current bumps, current spikes, current interruptions, etc.) to the field device 112.

To enter a third state (e.g., the secondary-active state 658 of FIG. 6B and as shown in FIG. 8), the secondary microcontroller 204b disables the secondary sink electrical current path corresponding to the secondary sink electrical current regulator circuitry 242 (block 958). For example, the secondary microcontroller 204b may disable the secondary sink electrical current path by causing the secondary sink switch circuitry 244 to open (e.g., turning off the secondary sink switch circuitry 244, blocking an electrical current path through the secondary sink switch circuitry 244, etc.). In the third state (e.g., the secondary-active state 658), the secondary microcontroller 204b has transitioned drive and control of the field device 112 from the symmetric drive state by the secondary I/O card 116b to the asymmetric drive state by both I/O cards 116a,b as shown in FIG. 8. The third state (e.g., the secondary-active state 658) is another incremental change to substantially reduce or prevent the likelihood of introducing electrical current disruptions to the field device 112. In some examples, the I/O cards 116a,b operate in the third state (e.g., the secondary-active state 658) for an extended duration as a normal operating state. In this manner, drive and control can be quickly moved to solely the secondary I/O card 116b if the primary I/O card 116a fails or can be quickly moved solely to the primary I/O card 116a if the secondary I/O card 116b experiences a failure. The example instructions or operations 950 of FIG. 9B end.

FIG. 10 is a block diagram of an example implementation of the microcontrollers 204a,b of FIGS. 2 and 3. In this example, the microcontrollers 204a,b of FIGS. 2 and 3 are implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 9A and 9B to effectively instantiate the circuitry of FIGS. 2 and 3 as logic circuits to perform operations corresponding to those machine-readable instructions. In some such examples, the circuitry of FIGS. 2 and 3 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine-readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine-readable instructions and/or operations represented by the flowcharts of FIGS. 9A and 9B.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory. Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer-based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

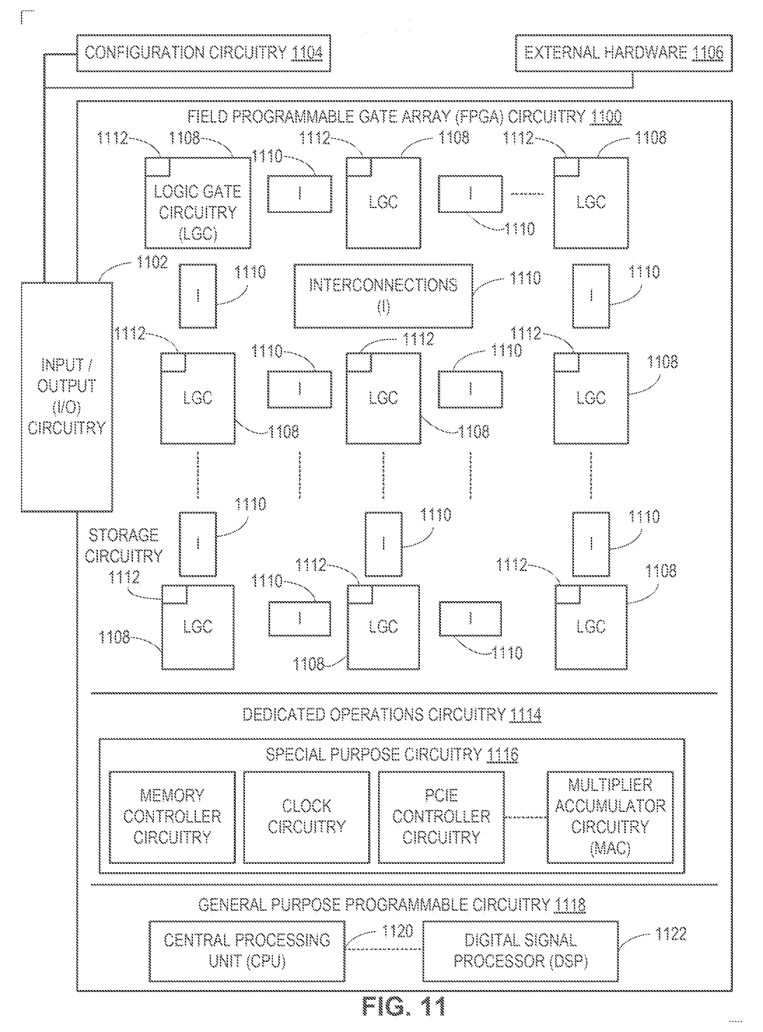

FIG. 11 is a block diagram of another example implementation of the microcontrollers 204a,b of FIGS. 2 and 3. In this example, the microcontrollers 204a,b are implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine-readable instructions. However, once configured, the FPGA circuitry 1100 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine-readable instructions represented by the flowcharts of FIGS. 9A and 9B but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine-readable instructions represented by the flowcharts of FIGS. 9A and 9B. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 9A and 9B. As such, the FPGA circuitry 1100 may be configured and/or structured to effectively instantiate some or all of the operations/functions corresponding to the machine-readable instructions of the flowcharts of FIGS. 9A and 9B as dedicated logic circuits to perform the operations/functions corresponding to those software instructions in a dedicated manner analogous to an ASIC. Therefore, the FPGA circuitry 1100 may perform the operations/functions corresponding to the some or all of the machine-readable instructions of FIGS. 9A and 9B faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine-readable instructions of FIGS. 9A and 9B and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the microcontrollers 204a,b of FIGS. 2 and 3, many other approaches are contemplated. For example, FPGA circuitry may include an on-board CPU, such as one or more of the example CPU 1120 of FIG. 10. Therefore, the microcontrollers 204a,b of FIGS. 2 and 3 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine-readable instructions represented by the flowcharts of FIGS. 9A and 9B to perform first operation(s)/function(s), the FPGA circuitry 1100 of FIG. 11 may be configured and/or structured to perform second operation(s)/function(s) corresponding to a second portion of the machine-readable instructions represented by the flowcharts of FIGS. 9A and 9B, and/or an ASIC may be configured and/or structured to perform third operation(s)/function(s) corresponding to a third portion of the machine-readable instructions represented by the flowcharts of FIGS. 9A and 9B.

It should be understood that some or all of the circuitry of FIGS. 2 and 3 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIGS. 2 and 3 may be instantiated, for example, in one or more threads executing concurrently and/or in series. For example, the microprocessor 1000 of FIG. 10 may execute machine-readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIGS. 2 and 3 may be implemented within one or more virtual machines and/or containers executing on the microprocessor 1000 of FIG. 10.

In some examples, each of the microcontrollers 204a,b of FIGS. 2 and 3 may be in one or more packages. For example, the microprocessor 1000 of FIG. 10 and/or the FPGA circuitry 1100 of FIG. 11 may be in one or more packages. In some examples, an XPU may be implemented by a microcontroller 204a,b of FIGS. 2 and 3, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, joined, and in circuit with) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately,” “about,” and “substantially” modify their subjects/values to recognize the potential presence of variations that occur in real-world applications. For example, “approximately,” “about,” and “substantially” may modify degrees of similarity or extents to which characteristics apply that may not be exact due to real-world imperfections as will be understood by persons of ordinary skill in the art. For example, “approximately,” “about,” and “substantially” may indicate such a tolerance range of +/- 10% unless otherwise specified herein.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement dual-drive redundant output structures. Disclosed systems, apparatus, articles of manufacture, and methods improve process control systems by, for example, providing improved fault tolerance. For example, examples disclosed herein decrease the likelihood of absolute failure at a common point of connection of a field device to a controller. Examples disclosed herein allow removing of failed drive and control components while creating substantially little or no drive and control disturbance to the field device. Examples disclosed herein also allow performing diagnostic analyses of operability of field devices to verify that the field devices are working properly or identifying failures corresponding to the field devices. Disclosed systems, apparatus, articles of manufacture, and methods are accordingly directed to one or more improvement(s) in the operation of a machine other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to provide a dual-drive redundant output in a control system, the apparatus comprising:
interface circuitry;
machine-readable instructions; and
at least one processor circuit to be programmed by the machine-readable instructions to:
at a first state:
enable a first source electrical current path corresponding to first source electrical current regulator circuitry in circuit with a first terminal to be coupled to a field device; and
enable a first sink electrical current path corresponding to first sink electrical current regulator circuitry in circuit with a second terminal to be coupled to the field device;
at a second state, enable a second sink electrical current path corresponding to second sink electrical current regulator circuitry in circuit with the second terminal; and
at a third state, disable the first sink electrical current path.

2. The apparatus of claim 1, wherein one or more of the at least one processor circuit is to enable the second sink electrical current path after detecting a presence of at least one of second source electrical current regulator circuitry or the second sink electrical current regulator circuitry.

3. The apparatus of claim 1, wherein the third state corresponds to an asymmetric drive state in which a first input-output card that includes the first source electrical current regulator circuitry sources electrical current to the field device and a second input-output card that includes the second sink electrical current regulator circuitry sinks the electrical current from the field device.

4. The apparatus of claim 1, wherein the first source electrical current regulator circuitry and the first sink electrical current regulator circuitry are on a first input-output card, the second sink electrical current regulator circuitry in a second input-output card.

5. The apparatus of claim 1, wherein one or more of the at least one processor circuit is to determine an error has occurred at the field device based on electrical current flow corresponding to at least one of the first terminal or the second terminal.

6. The apparatus of claim 1, further including first communication circuitry to provide a signal to the first source electrical current path, the signal to be communicated to the field device.

7. The apparatus of claim 6, wherein the signal is to include information specifying a type of the field device.

8. An apparatus to provide a dual-drive redundant output in a control system, the apparatus comprising:
source electrical current regulator circuitry having an output;
first switch circuitry having a first terminal coupled to the output of the source electrical current regulator circuitry, and having a second terminal coupled to a first device interface terminal, the first device interface terminal to be coupled to a field device in the control system;
sink electrical current regulator circuitry having an input coupled to a second device interface terminal, and having an output, the second device interface terminal to be coupled to the field device in the control system; and
second switch circuitry having a first terminal coupled to the output of the sink electrical current regulator circuitry, and having a second terminal coupled to ground.

9. The apparatus of claim 8, further including:
source electrical current measurement circuitry coupled to the source electrical current regulator circuitry; and
sink electrical current measurement circuitry coupled to the sink electrical current regulator circuitry.

10. The apparatus of claim 9, wherein the source electrical current measurement circuitry is to measure a first electrical current output by the source electrical current regulator circuitry, the sink electrical current measurement circuitry to measure a second electrical current output by the sink electrical current regulator circuitry.

11. The apparatus of claim 9, further including a microcontroller having an input coupled to the output of the source electrical current measurement circuitry.

12. The apparatus of claim 11, wherein the microcontroller is to determine an error has occurred at the field device based on an electrical current measurement corresponding to at least one of the first device interface terminal or the second device interface terminal.

13. The apparatus of claim 8, wherein the source electrical current regulator circuitry and the sink electrical current regulator circuitry are on a first input-output card, the apparatus including a second input-output card, the second input-output card including:
second source electrical current regulator circuitry having an output;
third switch circuitry having a first terminal coupled to the output of the second source electrical current regulator circuitry, and having a second terminal coupled to the first device interface terminal;
second sink electrical current regulator circuitry having an input coupled to the second device interface terminal, and having an output; and
fourth switch circuitry having a first terminal coupled to the output of the second sink electrical current regulator circuitry, and having a second terminal coupled to ground.

14. The apparatus of claim 13, wherein the first input-output card and the second input-output card are to operate in an asymmetric drive state in which the source electrical current regulator circuitry of the first input-output card sources electrical current to the field device and the second sink electrical current regulator circuitry of the second input-output card sinks the electrical current from the field device.

15. The apparatus of claim 8, further comprising a first current back-feed prevention component having an input and an output, the second terminal of the first switch circuitry coupled to the first device interface terminal via the first current back-feed prevention component based on the input of the first current back-feed prevention component coupled to the second terminal of the first switch circuitry and the output of the first current back-feed prevention component coupled to the first device interface terminal.

16. A method comprising:
at a first state:
enabling a first source electrical current path corresponding to first source electrical current regulator circuitry in circuit with a first terminal to be coupled to a field device; and
enabling a first sink electrical current path corresponding to first sink electrical current regulator circuitry in circuit with a second terminal to be coupled to the field device;
at a second state, enabling, by at least one processor circuit programmed by at least one instruction, a second sink electrical current path corresponding to second sink electrical current regulator circuitry in circuit with the second terminal; and
at a third state, disabling, by one or more of the at least one processor circuit, the first sink electrical current path.

17. The method of claim 16, wherein the enabling of the second sink electrical current path is after detecting a presence of at least one of second source electrical current regulator circuitry or the second sink electrical current regulator circuitry.

18. The method of claim 16, wherein the third state corresponds to an asymmetric drive state in which a first input-output card that includes the first source electrical current regulator circuitry sources electrical current to the field device and a second input-output card that includes the second sink electrical current regulator circuitry sinks the electrical current from the field device.

19. The method of claim 16, further including determining an error has occurred at the field device based on electrical current flow corresponding to at least one of the first terminal or the second terminal.

20. The method of claim 16, further including providing a first signal to the first source electrical current path, the first signal to be communicated to the field device.
